(19) United States
(12) Patent Application Publication
(10) Pub. No.: US 2006/0038424 A1
(43) Pub. Date: Feb. 23, 2006

(54) Instrument panel structure for a vehicle

(75) Inventors: Masaru Aoki, Tokyo (JP); Toru Nakagawa, Souka-shi (JP); Osamu Mihashi, Tokyo (JP)

Correspondence Address: LAHIVE & COCKFIELD, LLP., 28 STATE STREET, BOSTON, MA, 02109, US

(73) Assignee: Honda Motor Co., Ltd., Minato-ku (JP)

(21) Appl. No.: 11/207,660

(22) Filed: Aug. 18, 2005

(30) Foreign Application Priority Data
Aug. 20, 2004 (JP) 2004-240695
Aug. 20, 2004 (JP) 2004-240696
Aug. 20, 2004 (JP) 2004-240697

(51) Int. Cl. B62D 25/14

(52) U.S. Cl. 296/70

(57) ABSTRACT

An instrument panel structure for a vehicle is provided with a front part instrument panel connected to the vehicle frame, which has a display portion for displaying vehicle information provided therein; and a rear part instrument panel supported by the front part instrument panel, which has a steering portion of the vehicle provided therein; wherein the front part instrument panel and the rear part instrument panel are disposed and spaced from each other in a lengthwise direction of the vehicle.

### BACKGROUND OF THE INVENTION

1. Field of the Invention

The present invention relates to an instrument panel structure for a vehicle.

Priority is claimed on Japanese Patent Application No. 2004-240695 filed on Aug. 20, 2004, Japanese Patent Application No. 2004-240696 filed on Aug. 20, 2004, and Japanese Patent Application No. 2004-240697 filed on Aug. 20, 2004, the contents of which are incorporated herein by reference.

2. Description of Related Art

With respect to an instrument panel structure for a vehicle, there is an instrument panel structure, the display visibility of which has been improved by forming a concave surface on the instrument panel and providing a display so as to erect the same at the driver's side of the concave surface with spacing (for example, refer to Japanese Unexamined Patent Application, First Publication No. H11-91405). Also, there is another instrument panel structure, in which the steering column is enclosed by upper and lower column covers, meters are disposed upwards of the front side of the upper column cover, a meter visor is caused to protrude from the instrument panel toward the vehicle compartment, a fold-back portion formed to be flush with the upper side of the upper column cover is provided at the lower part of the meter visor, and the upper surface of the upper column cover and the fold-back portion are made black, thereby improving the visibility of the meters (for example, refer to Japanese Unexamined Patent Application, First Publication No. 2003-226161).

Also, with respect to the front pillar portion structure of a vehicle, there is still another instrument panel structure, the forward view of which is expanded by dividing the front pillar portion into a forward front pillar portion and a rearward front pillar portion that has a greater section than that of the forward front pillar portion, wherein the visibility is improved. (for example, refer to Japanese Unexamined Patent Application, First Publication No. 2003-276638).

In connection with the instrument panel structure for a vehicle, various demands have been brought to light in addition to those regarding improvement in the visibility of the display and meters. One of the demands resides in that schemes for the instrument panel structure are required in order that the space in the compartment looks wide.

### SUMMARY OF THE INVENTION

It is therefore an object of the present invention to provide an instrument panel structure for a vehicle which enables the space in the compartment to look wide and is capable of improving the visibility of meters, etc.

It is another object of the present invention to provide an instrument panel structure for a vehicle, which is capable of disposing the front pillar portion and the instrument panel in a well-balanced state when the front pillar portion is divided into a front part and rear part and the instrument panel is divided into a front part and rear part.

It is still another object of the present invention to provide an instrument panel structure for a vehicle, which is capable of improving the degree of freedom for disposing the outlets of air of an air-conditioning unit.

An instrument panel structure for a vehicle according to the present invention includes a front part instrument panel connected to the vehicle frame and having a display portion provided therein for displaying vehicle information; and a rear part instrument panel supported by the front part instrument panel and having a steering portion of the vehicle provided thereon, wherein the front part instrument panel and the rear part instrument panel are disposed and spaced from each other in the lengthwise direction of the vehicle.

In the present invention, it is preferable that the steering portion be made movable in the lengthwise direction of the vehicle with respect to the rear part instrument panel.

According to the present invention, since the front part instrument panel and the rear part instrument panel are disposed and spaced from each other in the lengthwise direction of the vehicle, it is possible to make the front part instrument panel small-sized. Further, it is possible to make the rear part instrument panel look as if it is floating in space, and it is possible to make the space in the compartment look wide.

In addition, since the display portion of meters, etc., is provided in the front part instrument panel, and the steering portion is provided in the rear part instrument panel, the display portion is disposed apart from the driver. Accordingly, it is possible for the driver to check the display portion without substantially drawing his sight line away from the front window. Therefore, the visibility of the meters, etc., can be improved.

According to the present invention, since the steering portion is made movable in the length direction of the vehicle with respect to the rear part instrument panel, the rear part instrument panel is fixed at a fixed position. Therefore, it is possible to simplify the structure of the front part instrument panel, which supports the rear part instrument panel.

In the present invention, it is preferable that the interior of the rear part instrument panel be formed into a hollow structure through which conditioned air flows, and the rear part instrument panel be provided with an outlet port from which conditioned air is discharged into a compartment.

In the present invention, it is preferable that the outlet port be made to open toward the front of the vehicle between the front and rear part instrument panel.

In the present invention, it is preferable that the interior of the front part instrument panel be formed into a hollow structure through which conditioned air flows, and the front part instrument panel be provided with an outlet port from which conditioned air is discharged into a compartment.

According to the present invention, since the interior of the rear part instrument panel is formed into a hollow structure through which conditioned air flows, and the rear part instrument panel is provided with an outlet port from which conditioned air is discharged into the compartment, it is possible to open the outlet port toward the front of the vehicle or outwardly in the widthwise direction of the vehicle. Therefore, it is possible to increase the degree of freedom in the disposing position of the outlet ports for conditioned air.

According to the present invention, since the outlet ports are made to open forward the front of the vehicle, it is possible to prevent conditioned air from being discharged toward occupants and prevent the conditioned air from being directly applied to the occupants.

In the present invention, it is preferable that the vehicle frame be the front pillar of the vehicle.

In the present invention, it is preferable that the front pillar be composed of a forward front pillar portion and a rearward front pillar portion, and the front part instrument panel be connected to the left and right of the forward front pillar portion, and the rear part instrument panel be disposed between left and right of the rearward pillar portion and is supported by the front part instrument panel.

In the present invention, it is preferable that the section of the forward front pillar portion be smaller than the section of the rearward front pillar portion.

According to the present invention, since the front part instrument panel is disposed between the left and right forward front pillar portions and the rear part instrument panel is disposed between the left and right front pillar portions, it is possible to dispose the front pillar, which is divided into the front and rear parts, and the instrument panel, which is divided into the front and rear parts, in a well-balanced state. Therefore, it is possible to improve the appearance thereof.

According to the present invention, since the section of the forward front pillar portion is smaller than the section of the rearward front pillar portion, and the left and right forward front pillar portions are connected to the front part instrument panel, the rigidity of the forward front pillar portion can be bolstered by the rigidity of the front part instrument panel.

According to the present invention, since the rigidity of the front part instrument panel is higher than the rigidity of the rear part instrument panel, it is possible to bolster the rigidity of the forward front pillar portion, which is more slender than the rearward front pillar portion, using the rigidity of the front part instrument panel.

### BRIEF DESCRIPTION OF THE DRAWINGS

FIG. 1 is a perspective view showing the front part of a vehicle in which an instrument panel structure according to the present invention is employed.

FIG. 2 is a front view showing the front part of the interior of the vehicle in which an instrument panel structure according to the present invention is employed.

FIG. 3 is an enlarged front view showing the front part of the interior of the vehicle in which an instrument panel structure according to the present invention is employed.

FIG. 4 is a side view showing the front part of the interior of the vehicle in which an instrument panel structure according to the present invention is employed.

FIG. 5 is a view showing the rear part instrument panel, when being observed from the forward side of the vehicle, at the front part of the interior of the vehicle in which an instrument panel structure according to the present invention is employed.

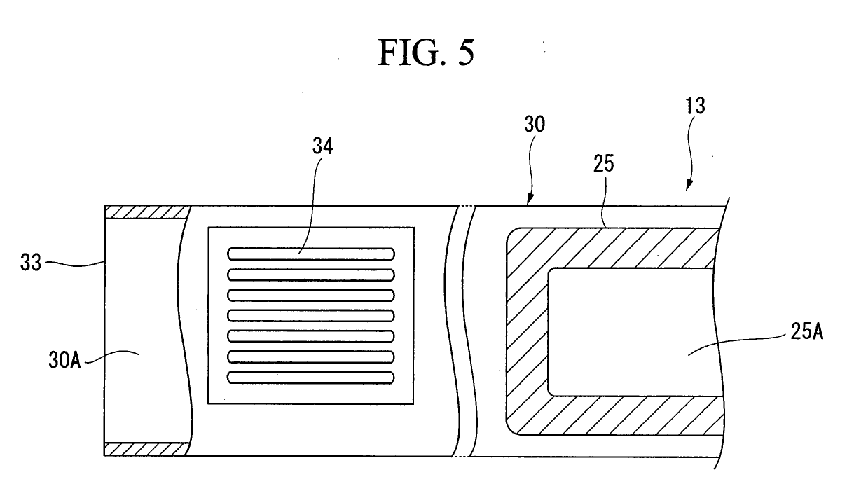

### DETAILED DESCRIPTION OF THE INVENTION

A description is given below of an embodiment of the present invention with reference to the drawings. Also, “forward and rearward” in the following description indicate directions in to the length (forward and rearward) of the vehicle.

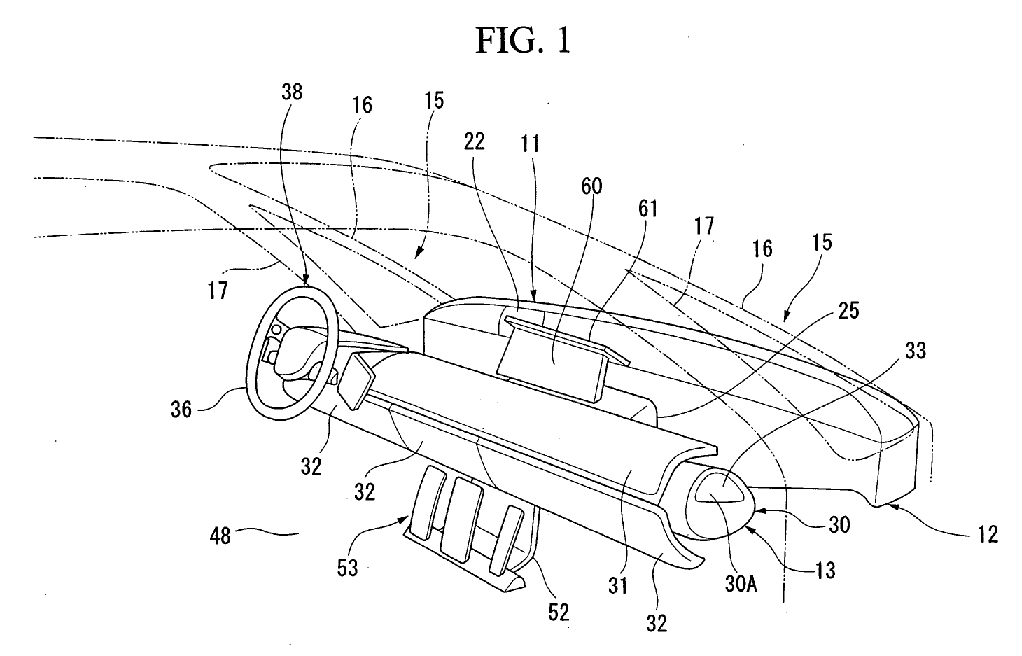

FIG. 1 shows the front part of the vehicle. In the present embodiment, an instrument panel 11 is divided into a front part instrument panel 12 and a rear part instrument panel 13. The front part instrument panel 12 and the rear part instrument panel 13 are disposed and spaced from each other in the lengthwise direction of the vehicle. A display portion 22 for displaying vehicle information is provided on the front part instrument panel 12, and the steering portion 38 of the vehicle is provided on the rear part instrument panel 13.

Also, in the embodiment, the left and right front pillars 15 that are parts of the vehicle frame are divided into the forward front pillar portion 16 and the rearward front pillar portion 17. The upper end part of the forward front pillar portion 16 is connected to the upper end part of the rearward front pillar portion 17, and the lower end part of the forward front pillar portion 16 and the lower end part of the rearward front pillar portion 17 are spaced from each other in the lengthwise direction of the vehicle. Herein, the section of the rearward front pillar portion 17 is greater than the section of the forward front pillar portion 16. Thus, by making the section of the forward front pillar portion 16 smaller, the field of forward view can be widened, and it is possible to secure satisfactory visibility.

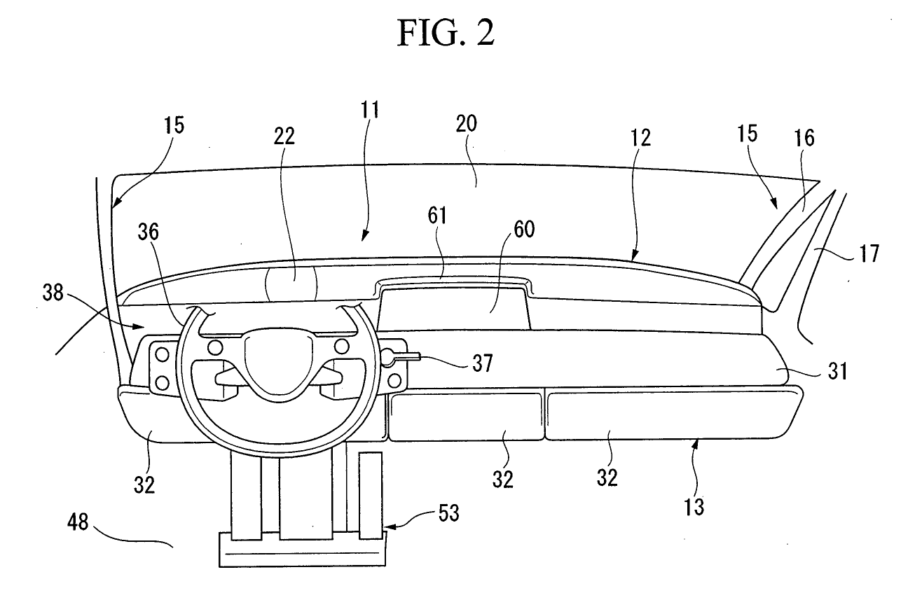

As shown in FIG. 2, the front part instrument panel 12 extends in the widthwise direction of the vehicle in the vicinity of the lower end edge part of the front window shield 20. The front part instrument panel 12 connects the left and right forward front pillar portions 16 together as shown in FIG. 1, and the rigidity of the left and right forward front pillar portions 16, the section of which is narrow, can be bolstered.

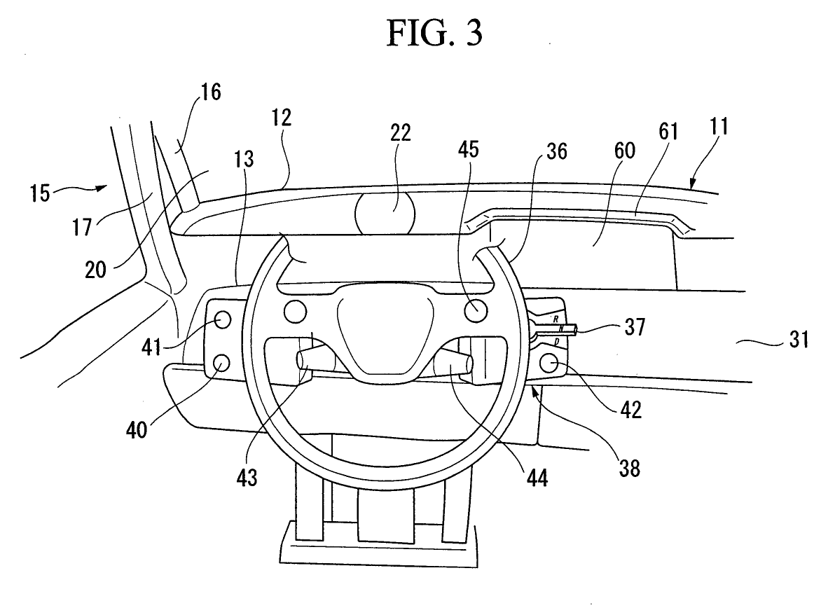

As shown in FIG. 2 and FIG. 3, a display portion 22 for displaying vehicle information such as vehicle speed to the driver is provided at the driver's seat side in the widthwise direction of the vehicle of the front part instrument panel 12. Since the display portion 22 is provided at the front part instrument panel 12, and the steering portion 38 is provided in the rear part instrument panel 13, the display portion 22 is disposed apart from the driver, whereby the driver is able to check the display portion 22 without greatly drawing his sight line away from the front window. Therefore, the visibility of the display portion 22 can be improved.

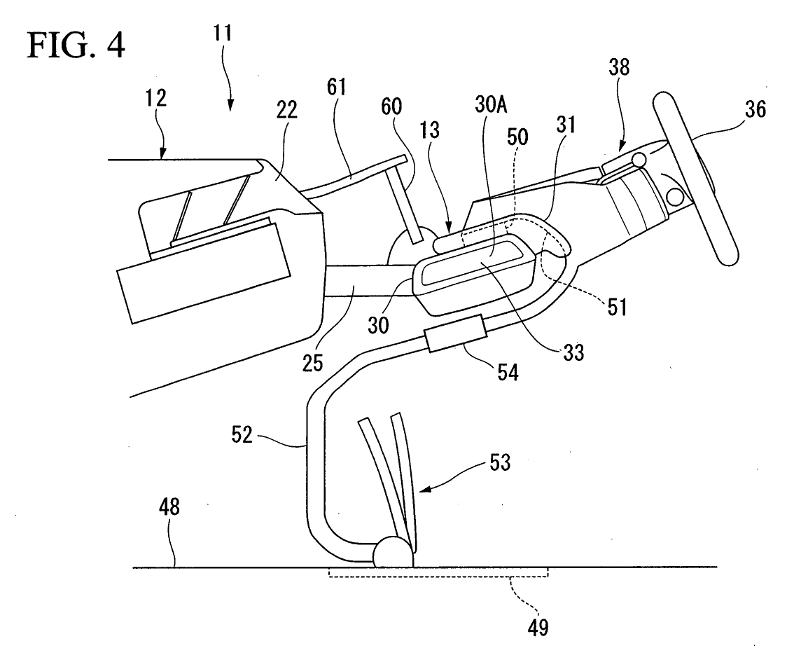

As shown in FIG. 1 and FIG. 4, a supporting portion 25 for supporting the rear part instrument panel 13 is provided at the rear part at the middle in the widthwise direction of the vehicle of the front part instrument panel 12. The supporting portion 25 is disposed roughly horizontally and extends rearward. The rear part instrument panel 13 is fixed at the rear end part of the supporting portion 25 so that it extends in the widthwise direction of the vehicle.

The rear part instrument panel 13 is supported by the front part instrument panel 12 via the supporting portion 25, and is provided between the left and right rearward front pillar portions 17 so as to be spaced from the rearward front pillar portions 17. Since high rigidity is not required for the rear part instrument panel 13, the rigidity of the rear part instrument panel 13 is made lower than the rigidity of the front part instrument panel 12, for which high rigidity is required to bolster the rigidity of the forward front pillar portions 16. That is, the rigidity of the front part instrument panel 12 is made higher than the rigidity of the rear part instrument panel 13.

The rear part instrument panel 13 is composed of a hollow-cylindrical main body portion 30, a cover member 31, and a knee bolster 32, etc. The main body portion 30 is made of, for example, a magnesium alloy, and is fixed at the supporting portion 25 in a state where it extends in the widthwise direction of the vehicle. The cover member 31 covers from the upper side to the rear side of the main body portion 30. The knee bolster 32 is provided below the main body portion 30.

As shown in FIG., 5, the supporting portion 25 is formed into a hollow structure having an interior space 25A. The interior space 25A of the supporting portion 25 communicates with the interior space 30A of the main body portion 30 of the rear part instrument panel 13. The interior space 25A functions as a path for conditioned air from an air conditioning unit (not illustrated) secured at the front part instrument panel 12 side and introduces conditioned air into the interior space 30A of the main body portion 30. The main body portion 30 of the rear part instrument panel 17 is formed into a hollow structure through which conditioned air can flow.

The main body portion 30 is made open at both sides thereof in the widthwise direction of the vehicle and the openings are made into an outlet port 33. In addition, an outlet port 34 which is open toward and discharges conditioned air forward is provided at the main body portion 30.

As shown in FIG. 1 through FIG. 4, a steering portion 38 is provided at the driver's seat side of the rear part instrument panel 13. The steering portion 38 includes a steering wheel 36, a shift lever 37, etc. Further, as shown in FIG. 3, a starter switch 40, an air conditioning unit control switch 41, a hazard switch 42, an audio switch 43, a switch 44 for a driver's support system, and an information switch 45, etc., are provided in the steering portion 38.

As shown in FIG. 4, in the floor 48a, slide rail portion 49 is buried so as to extend in the lengthwise direction of the vehicle. A leg portion 52 for supporting the steering portion 38 is provided so as to be slidable in the lengthwise direction of the vehicle along the slide rail portion 49. Operation pedals 53 are provided on the leg portion 52.

A notched portion 51 is formed at the lower part of the front side of the steering portion 38. The notched portion 51 is capable of receiving the rear part instrument panel 13 when the steering portion 38 is moved forward. A slide portion 50 is provided between the notched portion 51 and the main body portion 30 of the rear part instrument panel 13. The steering portion 38 is supported at the rear part instrument panel 13 slidably in the lengthwise direction of the vehicle via the slide portion 50.

Further, the leg portion 52 is provided with an adjustment portion 54. The adjustment portion 54 can adjust the position of the operation pedals 53 in the lengthwise direction of the vehicle with respect to the steering portion 38.

By causing the leg portion 52 to slide in the lengthwise direction of the vehicle along the slide rail portion 49 as necessary, causing the steering portion 38 to slide in the lengthwise direction of the vehicle along the slide portion 50 with respect to the rear part instrument panel 13, and adjusting the position of the operation pedals 53 with respect to the steering portion 38 by means of the adjustment portion 54, the positions of the steering portion 38 and operation pedals 53 in the lengthwise direction of the vehicle can be adjusted.

Operation input into the steering portion 38 is inputted into a control unit (not illustrated) via electric cables none of which are illustrated. The electric cables extend to the front part instrument panel 12 side through the inside of the supporting portion 25.

A center multi-monitor 60 for display such as that of a car navigation system, etc., is provided at the upper central portion of the main body portion 30 of the rear part instrument panel 13. Also, a visor 61 is provided between the upper part of the center multi-monitor 60 and the front part instrument panel 12 upward of the supporting portion 25. The supporting portion 25 is covered up by the visor 61.

According to the embodiment described above, since the front part instrument panel 12 and the rear part instrument panel 13 are disposed and spaced from each other in the lengthwise direction of the vehicle, the front part instrument panel 12 can be made small-sized. Further, it is possible for the rear part instrument panel 13 to be made to look as if it is floating in space, are it is possible to make the space in the compartment look wide.

Also, since the display portion 22 of meters, etc., is provided in the front part instrument panel 12 and the steering portion 38 is provided at the rear part instrument panel 13, the display portion 22 is disposed apart from the driver. Accordingly, the driver is able to check the display portion 22 without greatly drawing his sight line away from the front window. Therefore, visibility of the meters, etc., can be improved.

Also, since the steering portion 38 is made movable in the lengthwise direction of the vehicle with respect to the rear part instrument panel 13, the rear part instrument panel 13 is fixed at a fixed position. Therefore, it is possible to simplify the structure of the supporting portion 25 for supporting the rear part instrument panel 13 of the front part instrument panel 12.

According to the embodiment described above, since the front part instrument panel 12 is disposed between the left and right forward front pillar portions 16, and the rear part instrument panel 13 is provided between the left and right rearward front pillar portions 17, it is possible to dispose the respective front pillar portions 16 and 17, which are separated in the lengthwise direction of the vehicle, and the instrument panels 12 and 13, which are separated in the lengthwise direction of the vehicle, in a well-balanced state. Therefore, the appearance can be improved.

Furthermore, since the section of the forward front pillar portion 16 is smaller than the section of the rearward front pillar portion 17, and the left and right forward front pillar portions 16 are connected to the front part instrument panel 12, the rigidity of the forward front pillar portion 16 can be bolstered by the rigidity of the front part instrument panel 12.

Also, since the rigidity of the front part instrument panel 12 is higher than the rigidity of the rear part instrument panel 13, it is possible to bolster the rigidity of the forward front pillar portion 16, which is more slender than the rearward front pillar portion 17, using the rigidity of the front part instrument panel 12.

According to the present invention, since the interior of the rear part instrument panel 13 is formed into a hollow structure through which conditioned air can flow, and the rear part instrument panel 13 is provided with outlet ports 33 and 34 that discharge conditioned air into the compartment, the outlet port 33 can be made to open outwardly in the widthwise direction of the vehicle, and the outlet port 34 can be made to open toward the front of the vehicle. Therefore, it is possible to prevent conditioned air from being discharged toward occupants and prevent the conditioned air from being directly applied to the occupants.

Note that, the front part instrument panel 12 is formed into a hollow structure through which conditioned air can flow, and an outlet port for discharging conditioned air into the compartment can be provided in the front part instrument panel 12.

While preferred embodiments of the present invention have been described and illustrated above, it should be understood that these are exemplary of the present invention and are not to be considered as limiting. Additions, omissions, substitutions, and other modifications can be made without departing from the spirit or scope of the present invention. Accordingly, the present invention is not to be considered as being limited by the foregoing description, and is only limited by the scope of the appended claims.

1. An instrument panel structure for a vehicle comprising:
a front part instrument panel connected to a vehicle frame of the vehicle, which has a display portion provided therein for displaying vehicle information; and
a rear part instrument panel supported by the front part instrument panel, which has a steering portion of the vehicle provided thereon;
wherein the front part instrument panel and the rear part instrument panel are disposed and spaced from each other in a lengthwise direction of the vehicle.

2. The instrument panel structure for a vehicle according to claim 1, wherein the steering portion is made movable in the lengthwise direction of the vehicle with respect to the rear part instrument panel.

3. The instrument panel structure for a vehicle according to claim 1, wherein an interior portion of the rear part instrument panel is formed into a hollow structure through which conditioned air flows, and the rear part instrument panel is provided with outlet ports which discharge the conditioned air into a compartment.

4. The instrument panel structure for a vehicle according to claim 3, wherein the outlet ports are made to open toward a front of the vehicle between the front and rear part instrument panel.

5. The instrument panel structure for a vehicle according to claim 1, wherein an interior portion of the front part instrument panel is formed into a hollow structure through which conditioned air flows, and the front part instrument panel is provided with outlet ports which discharge the conditioned air into a compartment.

6. The instrument panel structure for a vehicle according to claim 1, wherein the vehicle frame forms a front pillar of the vehicle.

7. The instrument panel structure for a vehicle according to claim 6, wherein the front pillar is composed of a forward front pillar portion and a rearward front pillar portion and the vehicle includes a left front pillar and a right front pillar;
the front part instrument panel is connected to the forward front pillar portion of the left and the right front pillars; and
the rear part instrument panel is disposed between the rearward pillar portion of the left and the right front pillars and is supported by the front part instrument panel.

8. The instrument panel structure for a vehicle according to claim 7, wherein a section of the forward front pillar portion is smaller than a section of the rearward front pillar portion.
